(19) United States
(12) Patent Application Publication
(10) Pub. No.: US 2003/0209477 A1
(43) Pub. Date: Nov. 13, 2003

(54) Transportable water treatment apparatus

(76) Inventor: Maurice Lacasse, Chambly (CA)

Correspondence Address: Robert Brouillette, BROUILLETTE KOSIE PRINCE, 25th Floor, 1100 Rene-Levesque Boulevard West, Montreal, QC, H3B 5C9, CA

(21) Appl. No.: 10/434,125

(22) Filed: May 9, 2003

(30) Foreign Application Priority Data
May 10, 2002 (CA) 2,385,828
Mar. 19, 2003 (CA) 2,422,608

(51) Int. Cl. B01J 20/00

(52) U.S. Cl. 210/198.1

(57) ABSTRACT

The present invention relates to a transportable apparatus for water treatment. More particularly, the apparatus is destined to be fully automated and provide drinkable water quality to small-size municipalities. The apparatus is connected to a raw water source and comprises, within its own transportable housing, all the necessary components to treat water. The water treatment process requires the use of various water treatment stages to gradually purify the water source, involving a series of filters and in a preferred embodiment, uses ozone as a disinfectant.

### FIELD OF THE INVENTION

The present invention relates to a transportable water treatment system using filters and ozone.

### BACKGROUND OF THE INVENTION

In today's world, water sources for human consumption or other uses can often contain contaminants and various pollution elements such as living organisms (bacteria, viruses, etc...), organic and inorganic substances causing unwanted odor and color to the water sources. Naturally it is desired to reduce the amount of contaminants in water, especially if the water is destined to be consumed by people.

In the past, water treatment systems have been mainly managed by municipalities, in order to accommodate the drinkable and recreational water needs of their population, and also treat wasted water. Lately, the increasing concerns regarding the environment, the norms associated to its protection and the emergence of larger scale projects in construction have changed the requirements and the mission of a water treatment systems. For instance, new applications for water treatment systems include large building and developing sites, little communities like remote plant workers and smaller municipalities. Also, available water sources can be of different nature, including surface waters or ground water.

These days, water treatment systems need to be more adaptable to various types of environments. They must use products and offer water quality following very strict environmental regulations and at the same time, be less expensive to be attractive to smaller municipalities and private interests.

Previous methods and systems for reducing contaminants in water have used, for example chlorine and ozone. Of these substances ozone recently has become the more and more popular since ozone is one of the most powerful oxidizers and disinfectants available.

Most state health codes for water mandate a controlled pH, a certain level for a sanitizer. The only sanitizers currently permitted are the hypochlorous acid, HOCl (customarily referred to as chlorine in the pool industry), and the less often used hypobromous acid, HOBr (likewise, referred to as bromine). However, most compounds that produce chlorine in water sources influence the pH. It is therefore necessary to add either an acidic or caustic substance to maintain the pH. This means that the water treatment systems need to have two injection systems: one for the selected sanitizer, and another one for the pH control.

On the other hand, ozone exhibits biocidal qualities concentrations over 0.4 parts per million, when dissolved in water. Ozone is a semi-stable gas formed of three oxygen atoms, instead of the two atoms that form oxygen gas. Ozone is most typically produced by an electrical arc discharged through air causing oxygen atoms to combine with an oxygen free radical that is formed. Ozone rapidly undergoes reaction to revert to more stable oxygen, releasing an oxygen free radical in the process. Two such free radicals can combine to form an oxygen molecule or the free radicals can oxidize an oxidizable substrate.

Ozone not only kills bacteria, but also inactivates many viruses, cysts and spores. In addition, ozone oxidizes many organic chemical compounds, including chloramines, soaps, oils and other wastes thereby rendering them harmless to the environment. Accordingly, ozone may be used for a number of purposes, including: purification of water used for drinking, in food cleaning and processing, in ice machines, in swimming pools and spas and waste water treatment.

Although ozone is especially beneficial for breaking down certain contaminants in water, obtaining an effective concentration of ozone in water may be difficult and may represent a more expensive solution in a water treatment system. At a high concentration, ozone is a toxic and corrosive gas which is considered to be a pollutant by The United States Environmental Protection Agency (EPA), such that special provisions must be made for the containment and removal of the excess ozone.

In the prior art, Mori et al. (U.S. Pat. No. 6,464,877) teaches about a water treatment process comprising the addition of ozone to raw water and the filtering of the raw water through an ozone resistant membrane. However, this invention necessitate the addition of a coagulant agent which needs the supply and the disposal of the chemical product and its reaction bi-products. Also, this invention does not disclose a fully transportable housing containing all the necessary components to fully operate a water treatment system .

Notwithstanding the existence of prior art ozone water treatment systems, it remains clear there is a need for a water treatment system that is automated, transportable and efficient.

Although modular ozone water treatment systems have been suggested, none are both easily transportable and capable of supplying the need of a small municipality. See, for example, U.S. Pat. Nos. 5,427,693 (Mausgrover et al.), 5,711,887 (Gastman et al.) and 6,027,642 (Prince et al).

### SUMMARY OF THE INVENTION

The object of the invention is to provide a complete and fully operational water treatment apparatus delivered with its own transportable housing and adapted to serve the water needs of small size municipalities.

It is also an object of this invention to provide an apparatus which uses a disinfecting substance like ozone, which is easily and efficiently removed from the water and which does not generate any significant amount of sludge that then has to be treated.

It is furthermore an object of this invention to provide an apparatus with various water filtration and purification stages which gradually purifies water without the addition of other chemical products.

It is furthermore an object of this invention to include after the main ozone and water reaction stage, a filtration component which partly auto-cleans itself by the passage of water still containing a controlled concentration of ozone.

There is therefore provided a water treatment apparatus to purify water coming from an external water source as water flows in said apparatus, said water source containing unwanted particles and /or substances and/or having high levels of turbidity, said apparatus comprising:

a transportable housing which is adapted to be connected to said water source;

a first filter which removes a portion of said unwanted particles from said water source;

a disinfectant generator system which produces and provides disinfectant,

a mixer which mixes said disinfectant with said water source from said first filter;

a reactor which defines an inner chamber connected to said mixer and favors the molecular reaction of said water source with said disinfectant to remove a significant portion of any remaining said unwanted particles and/or substances and inactivate another portion of the left said unwanted particles and/or substances;

There is furthermore provided a water treatment apparatus to purify water coming from an external water source as water flows in said apparatus, said water source containing unwanted particles and /or substances and/or having high levels of turbidity, said apparatus comprising:

a transportable housing which is adapted to be connected to said water source;

a first filter which removes a portion of said unwanted particles from said water source;

a disinfectant generator system which produces and provides disinfectant,

a mixer which mixes said disinfectant with said water source from said first filter;

a reactor which defines an inner chamber connected to said mixer and favors the molecular reaction of said water source with said disinfectant to remove a significant portion of any remaining said unwanted particles and/or substances and inactivate another portion of the left said unwanted particles and/or substances;

a second filter which removes another portion of said unwanted particles and/or substances from said water source;

a third filter which lowers the turbidity level and lowers said disinfectant in said water source;

a fourth filter which lower said inactivated unwanted particles and/or substances from said water source.

There is furthermore provided a method of installing a water treatment system using an ozone generator means at an installation location, said method comprising the steps of:

a. building the water treatment system at a location remote to the installation location;

b. installing the water treatment system in an enclosure such that the water treatment system can be relocated by moving the enclosure, and such that the water treatment system can treat a water source external to said enclosure without being removed from said enclosure;

c. transporting said enclosure to the installation location; and

d. installing the enclosure at the installation location.

Other aspects and many of the attendant advantages will be more readily appreciated as the same becomes better understood by reference to the following detailed description and considered in connection with the accompanying drawings in which like reference symbols designated like elements throughout the figures.

The features of the present invention which are believed to be novel are set forth with particularity in the appended claims.

### BRIEF DESCRIPTION OF THE DRAWINGS

FIG. 1 is a isometric view of a transportable water treatment apparatus according to the present invention;

FIG. 2a is the first portion of a schematic diagram of the apparatus shown in FIG. 1;

FIG. 2b is the second portion of the schematic diagram shown in FIG. 2a;

FIG. 3 is an isometric view of the rotative screening system of the apparatus shown in FIG. 1;

FIG. 4 is a partial isometric view of the rotative screening system shown in FIG. 3;

FIG. 5 is another partial isometric view of the rotative screening system shown in FIG. 3;

FIG. 6 is a partial isometric view of the dual rotative screening system of the apparatus shown in FIG. 1;

FIG. 7 is another partial isometric view of the dual rotative screening system shown in FIG. 6;

FIG. 8 is a section view of the ultra-micro-filtration membrane of the apparatus shown in FIG. 1;

FIG. 9 is a partial isometric view of the ultra-micro-filtration membrane shown in FIG. 8;

FIG. 10 is another partial isometric view of the ultra-micro-filtration membrane shown in FIG. 8;

FIG. 11 is a schematic diagram of an ozone generation apparatus according to the present invention for use in a potable water treatment system;

FIG. 12 is a schematic view of a self contained mobile ozone water treatment apparatus according to the present invention;

FIG. 13 is a schematic view of another self contained mobile ozone water treatment apparatus according to the present invention;

FIG. 14 is a perspective view of the housing of the modular ozone water treatment apparatus as shown in FIG. 13.

### DETAILED DESCRIPTION OF A PREFERRED EMBODIMENT

This invention relates to a transportable water treatment system which consist in a prefabricated water treatment plant delivered with its own housing.

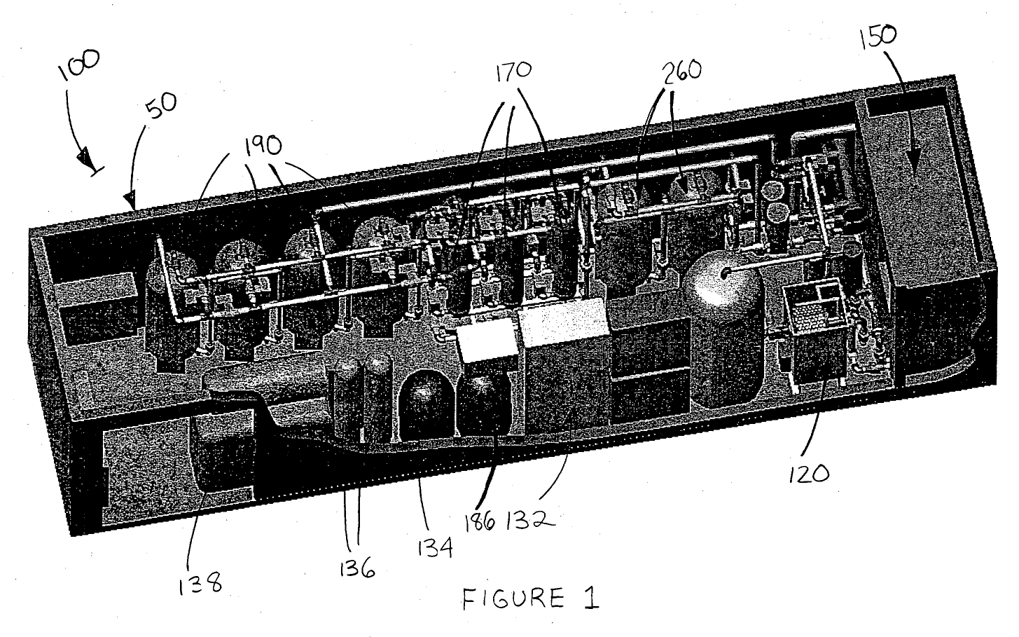

FIG. 1 shows the apparatus 100 which usually provides small and medium-sized municipalities with access to powerful, affordable and easy to use water treatment technology. The apparatus 100 treats different types of water sources like surface water, groundwater which has been contaminated by surface water, or simply contaminated water in the sense of a water source not complying with regulations regarding quality for the desired water uses.

The apparatus 100 is fully automated and preferably uses an ozonation process combined with multiple levels and various types of filtration processes, which will be explained hereinafter.

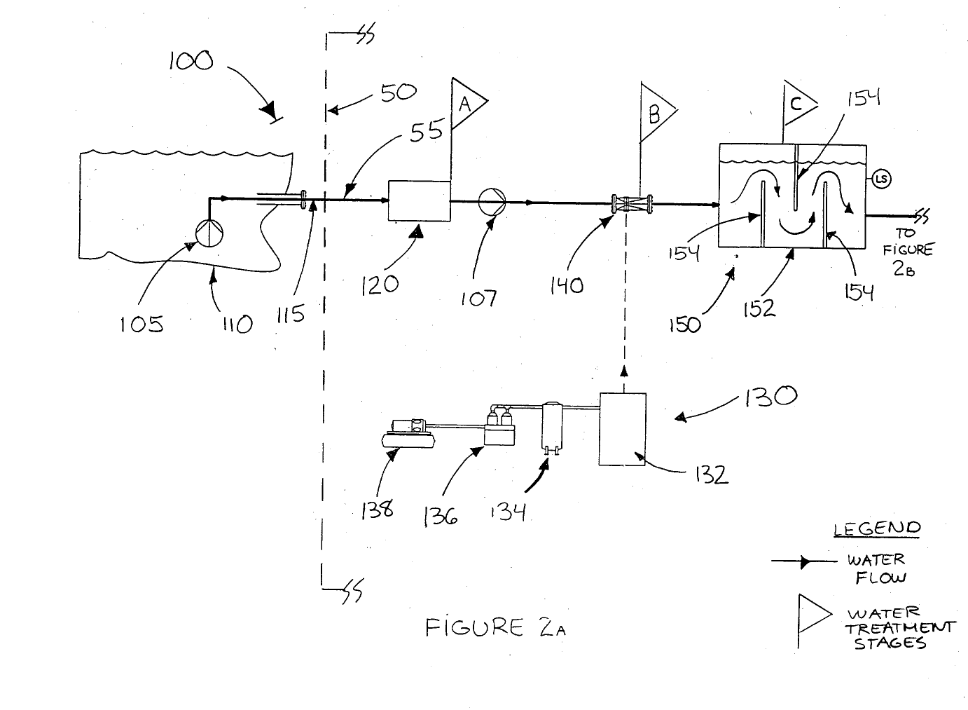

FIGS. 2a and 2b schematically illustrate the apparatus 100 and its components. The external raw water source 110 is linked to the housing 50 via an external piping system 115 and an external pump 105.

Once the water enters the housing 50, it is carried by an internal piping system 55 to various water treatment stages. Stage A consist in a filtration process provided by a rotative screening system 120.

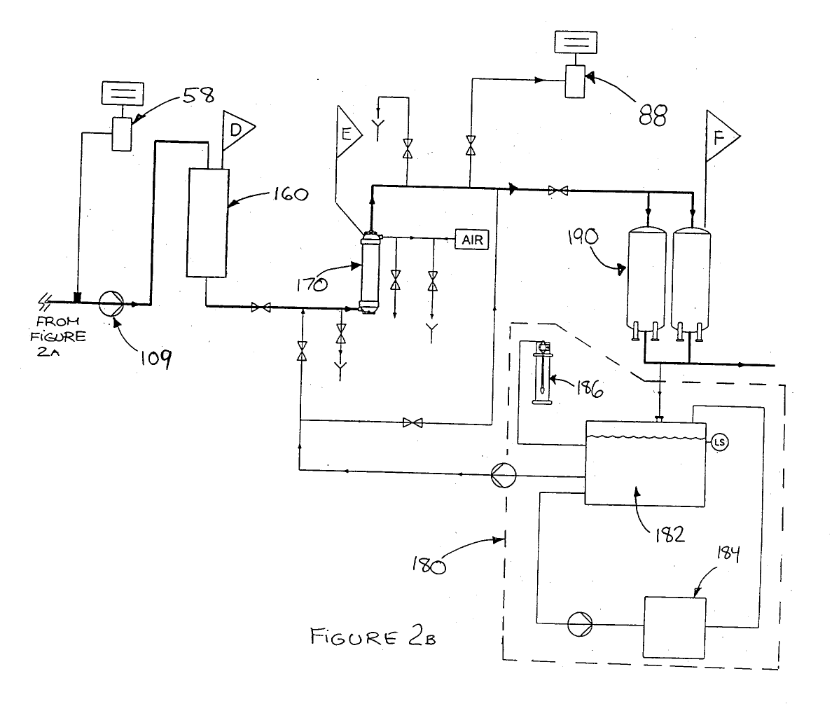

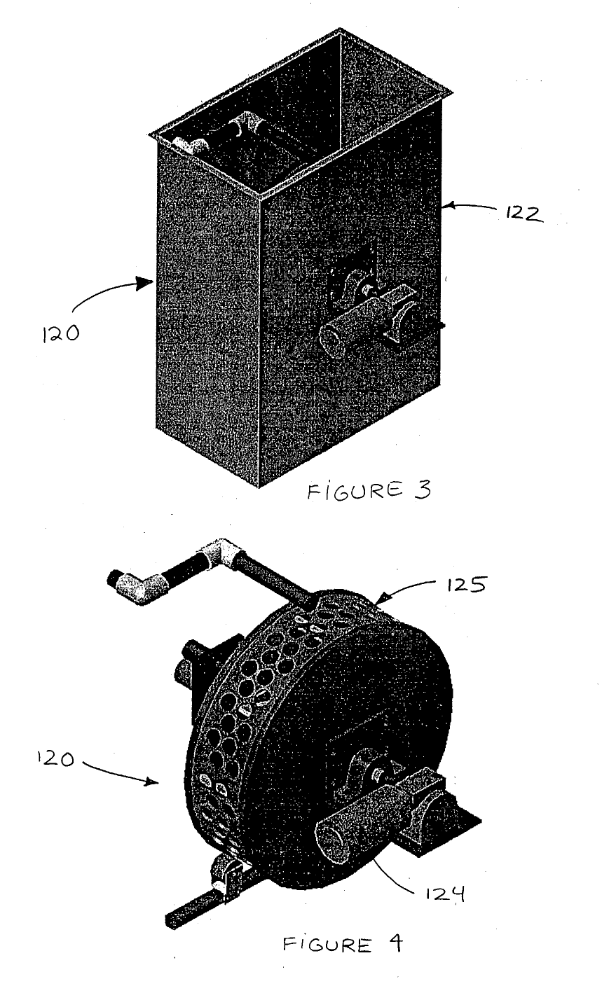

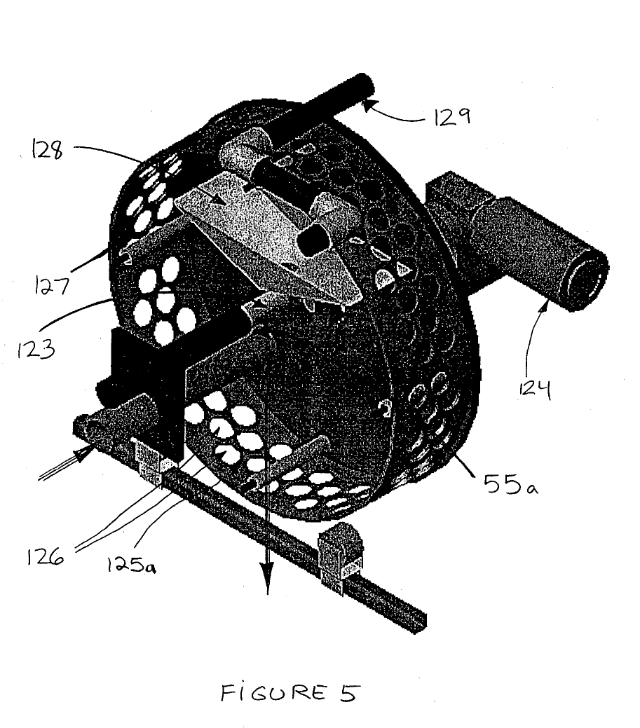

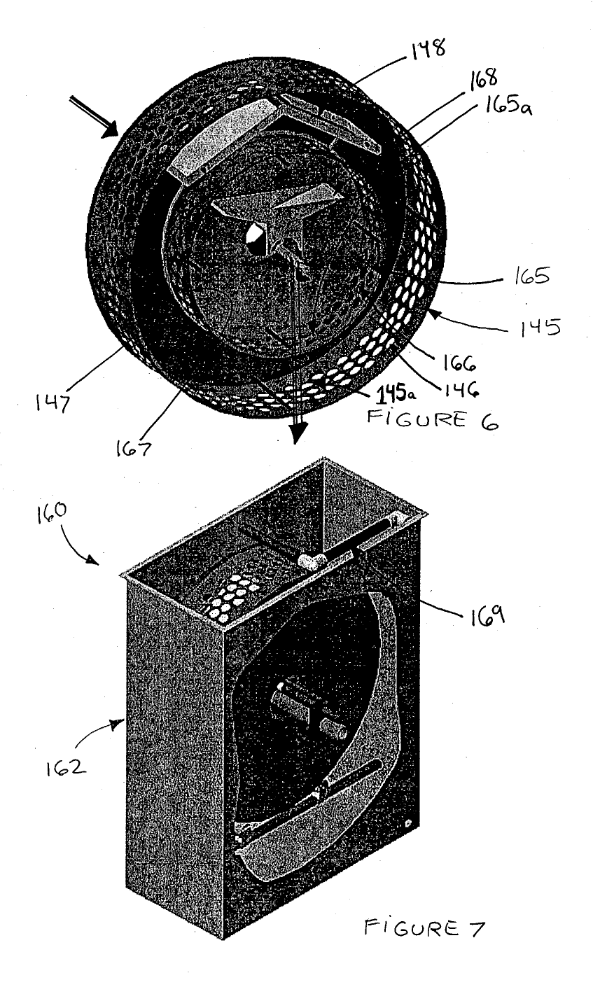

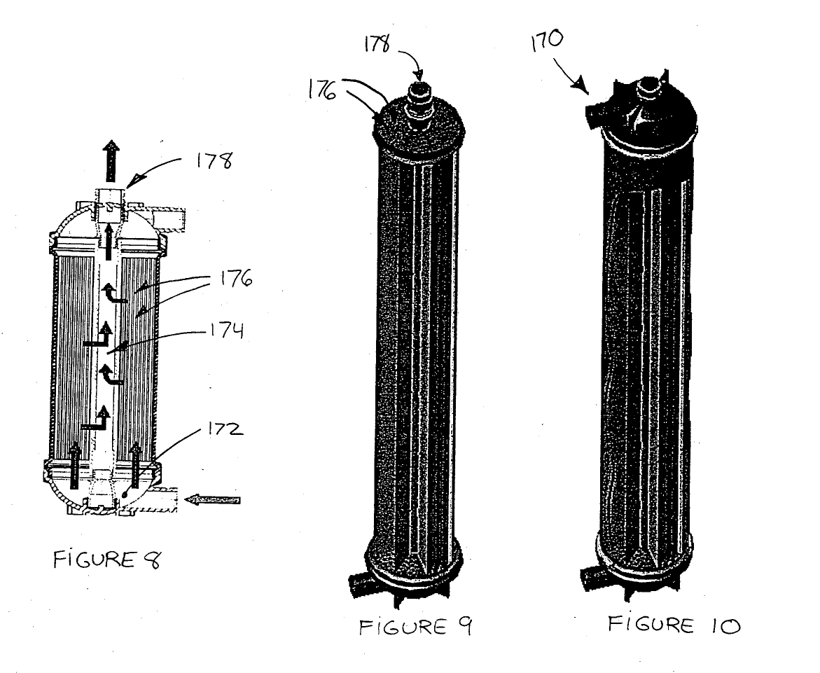

As seen in FIGS. 3, 4 and 5, the rotative screening system 120 comprises a container 122, into which a drum 125 is rotatably mounted. The drum 125 preferably has a cylindrical shape and a plurality of openings 126 around its circumference. A membrane (not shown) is attached on the inner surface 127 of the drum 125. As the water momentarily leaves the internal piping system 55a, gravity forces the water down to diffuse through the membrane (not shown) in the drum's lower portion 125a, then through the openings 126 and finally out of the rotative screening 120. The water is then recuperated at the bottom of the screening 120 and put back into the internal piping system 55.

In this embodiment, the membrane is a fabric type material which has a porosity of about 21 μm, such that a first effective filtration of particles in suspension is done.

As the membrane gets filed with debris, the filtration rate diminishes and the water level rises in the drum 125. When a critical water level is reached, it is detected via the use of a detector (not shown) and an automatic cleaning mode is initiated, which causes the actuation of a motor 124. The drum 125 is therefore rotated such that its lower portion 125a is put in between an inner cavity 128, which is connected to a drain 123, and water jet means 129. The water coming out under pressure from the jets means 129 removes the debris from the membrane (not shown) which are drained in the inner cavity 128, and flushed out of the rotative screening 120 from the drain 123.

In another embodiment, the rotative screening system could be replaced by a known pressure filter or strainer.

As seen in FIG. 2a, the water is preferably re-pressurized by a pump 107 before entering the stage B, where a venturi 140 provides means to mix the water and the disinfectant, which is dissolved into water at this exact stage. The venturi 140 is preferably used because it has a high efficiency rate for dissolving ozone into water, but any other device efficiently dissolving ozone into water could be used.

In raw waters, various types of contaminants can make water improper for human consumption. Known contaminants which need to be removed from raw water includes viruses, organic matters which gives an undesired color to the water, sediments and metals which influence the turbidity or the number of particles in suspension in water.

In the prior art, the addition of a coagulant agent in raw water sources allows a chemical reaction with some of the contaminants. However, those reaction bi-products comes in the form of sludge which has to be physically separated from the water source either by a mechanical process or it has to settle at the bottom of a recipient.

In the apparatus 100, the addition of ozone as a decontaminating substance, after the first filtration process of stage A, offers a solution which as the advantages of disinfecting (inactivating micro-organisms), removing the undesired color, oxidizing the unwanted metals and significantly lowering the turbidity level of water, without many of the side effects associated to the use of chlorine as a disinfectant.

A complete ozone generator system 130 included in the apparatus 100 independently generates ozone prior to-its injection into water. A system as disclosed in co-pending application CA 2,385,828 is preferably used to generate ozone, but any other ozone generator system having its components contained in the housing 50 can be used to supply the apparatus 100 with ozone.

In the preferred embodiment, the ozone generator system 130 comprises an air compressor 138, an oxygen generator 136, an oxygen reservoir 134, and an ozone generator 132. Ozone is therefore generated in the ozone generator 132 and fed to the venturi 140 in order to be dissolved into water. More than one ozone generator 132 can be added to the ozone generating system 130, depending on their respective ozone production capacity and the required quantity to adequately treat the water.

In another embodiment, dehumidified air can be directly injected in the ozone generator 132 to provide ozone.

Stage C involves an ozone reactor 150. The ozone reactor 150 preferably comprise two reservoirs (152, only one shown) in parallel, each having transversal walls 154 with respect to the water flow direction. In this embodiment, the water remains approximately 15 minutes in the reactor 150 to ensure a proper disinfecting process as the water flows around the transversal walls 154 and reacts with the ozone. Ozone (0₃) naturally looks for something in its immediate environment to react with. When ozone is mixed with water and encounters metallic elements, bacteria, a virus or many other micro-organisms, the third atom of oxygen in the ozone is freed and instantly reacts with the particle encountered. The particle is instantly destroyed or inactivated and the ozone then turns back into oxygen (0₂).

However, a small quantity of ozone may still be present in water at the exit of the ozone reactor 150. As illustrated in FIG. 2b, an ozone analyzer 58 is located after stage C in order to control and ensure that a proper ozone concentration is maintained in the water. At the exit of stage C, the ozone concentration into water should preferably be around 0.8 mg/L.

Before entering stage D, the water may have to be re-pressurized by a pump 109. Stage D consists in a filtration process which preferably involves a dual rotative screening system 160, or any other known effective filtration system..

The dual rotative screening system 160 is shown in details in FIGS. 6 and 7 and its mode of operation is similar to the one of the rotative screening system 120 used in the first stage of water treatment. The dual rotative screening system 160 comprises a container 162, into which a first drum 165 and a second drum 145 are rotatably mounted. The drums 165,145 preferably have a cylindrical shape, the first drum 165 being concentric with respect to the second drum 145. The first drum 165 is also preferably contained within the second drum 145 such that their respective membranes (not shown) are vertically aligned. A plurality of openings 166,146 are also located around their respective circumferences.

The membrane (not shown) is attached on each inner surface 167,147 of the drums 165,145. As the water enters axially the dual rotative screening system 160, gravity forces the water to diffuse through the membrane (not shown) in the area of the first drum's lower portion 165a, then through its openings 166. The filtered water therefore reach the second drum's lower portion 145a and diffuse the same way through its membrane (not shown), then its openings 146, and finally out of the dual rotative screening system 160. The water is then recuperated at the bottom of the screening system 160 and put back into the internal piping system (not shown).

In this embodiment, the membrane of the first drum 165 has a porosity of about 15 μm, and the membrane of the second drum 145 has a porosity of about 10 μm, and both membrane are also preferably made of fabric type materials.

As the membranes gets filled with debris, the filtration rate is reduced and the water levels also rise in the drums 165,145. When critical water levels are reached, an automatic cleaning mode similar to the one described above in relation to the rotative screening system 125 in the first water treatment stage, is initiated and actuates a motor (not shown), uses inner cavities 168,148 and water jet means 169 to clean the membranes.

In another embodiment, stage D could be replaced by sand/anthracite filters (260 in FIG. 1). Each filter 260 comprises a succession of layers of sand and anthracite (not shown) in order to reduce the turbidity level before entering stage E.

After exiting stage D, the water preferably still contains a controlled amount of ozone which is dissolved in it, and the rough filtrations of stages A and D have separated from the water a large proportion of any debris. However, the main filtration step occurs at stage E, where the ozone concentration left in the water still participates in purifying the water, without the need to add any other chemical products. Also, the inactivated debris generated in stage C with the use of ozone are more easily filterable and removable in stage E.

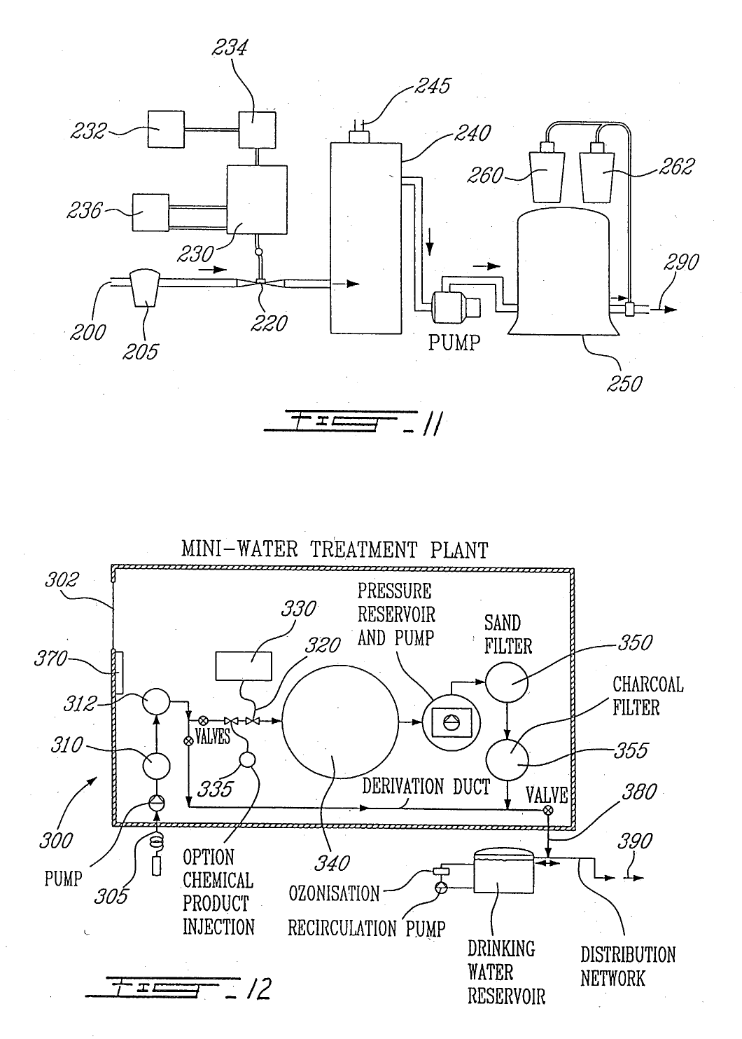

At stage E, an ultra-micro-filtration membrane 170 is introduced in the apparatus 100 to significantly reduce the turbidity level. FIGS. 8, 9 and 10 illustrate the ultra-micro-filtration membrane 170 which comprises a water container entrance 172, opening to thousands of vertically extending capillaries 176. A capillary-less central channel 174 has one of its end 178 connecting the ultra-micro-filtration membrane 170 back to the internal piping system 55.

The capillaries 176 are permeable to water, such that when the water is forced from the entrance 172 and into the capillaries 176, the water filters out of the capillaries, into the central channel 174, as illustrated in FIG. 8. Most of the particles still in suspension at this stage which causes turbidity are kept inside the capillaries 174, which have an approximate porosity of about 0.1 μm.

In another embodiment, the ultra-micro-filtration membrane 170 can be used in a reverse way, such that the water to be purified enters in the central channel 174, and then forced to filter into the capillaries 176 and out of the ultra-micro-filtration membrane 170. In a similar way to the principle described hereinabove, the particles in suspension are therefore separated from the water.

Depending on the direct or reverse mode of operation of the ultra-micro-filtration membrane, the particles in suspension are either stuck on the inside or outside surface of the capillaries 176. As water to be filtered reaches stage E, the ozone which is still dissolved into it provides a certain level of self-cleaning to the ultra-micro-filtration membrane since the ozone can still react with the debris stuck on the surfaces of the capillaries 176. This feature helps at the same time to lower the concentration of the remaining ozone in water. However, to have this feature work, the membrane must evidently be resistant to the disinfectant.

An independent cleaning system is also incorporated to the ultra-micro-filtration membrane 170, but it will be explained hereinafter. Before entering the final stage F of filtration, the turbidity level of water is preferably measured by a turbidity analyzer 88.

At this stage in the water treatment process, the ozonation has dealt with some of the organic carbons generated by the inactivation of the microbiological matters. However, some of the organic carbons may still be dissolved in water after leaving stage E.

In stage F the water gets filtered through biological activated charcoal filters 190, as shown in FIG. 2b. These filters may comprise bacteria developed in a controlled environment to significantly reduce the quantity of organic carbon still present.

During the whole water treatment process, no other chemical products are added to chemically react with the water contaminants or to make the water cleaner or clearer.

Ozone is injected in a gaseous form and its unstable molecular structure react with contaminants to generate oxygen, or simply separate from water. No chlorines or other similar disinfectant are required from the apparatus 100.

For drinking water quality, municipalities often require the addition of chlorine in the distribution network of treated water in order to avoid a potential recontamination. However, the reaction of chlorine with organic carbons generate Tri-Halo-Methane (THM), for which high concentrations in water may be improper for human consumption. This addition of chlorine in water is not conducted by the apparatus 100 described herein, but with the presence of the biological activated charcoal filters 190, the level of organic carbons is greatly diminished. If chlorine is therefore required, its concentration will then be very low and generate less THM.

Finally, the apparatus 100 comprises an alternate circuit 180 which provides means to clean the internal piping 55 and the components 170, 190 which do not have an integrated cleaning circuit. The cleaning circuit 180 comprises a treated water reservoir 182, a pump with chemical cleaning products 186 and a water heater 184. The cleaning product used is preferably hydrogen peroxide or sodium hypochlorite.

In another embodiment, UV lamps (not shown) are added to provide final disinfections to the treated water for an additional disinfection as a last water treatment stage.

The reservoir is filled with a portion of the filtered water coming out of the biological activated charcoal filters 190, at the exit of stage F. The inner water level is automatically regulated by a control system (not shown). The reservoir 182 is also preferably connected to the piping system 55 in a closed-loop between stage D and stage E and exits after stage F.

All the functionalities and each components of the apparatus 100 are fully automated and delivered with a control computer that continuously monitors the quality of treated water for turbidity and disinfection, verifies the proper operation of the plant, initiates various scheduled tasks and maintenances and relays data over a remote surveillance network.

FIG. 11, shows a water treatment system according to another embodiment of the invention. This water treatment system is designed for use with a potable water supply and uses a combination of ozone and chlorine. Chlorine is used because ozone is an unstable molecule and will only last for a short period of time. Therefore if the water does not reach its end destination before the breakdown time of the ozone the water risks becoming polluted again if the aqueduct is defective, which is often the case. Chlorine, however, is very stable and can therefore be used to keep the water clean from the time it leaves the water treatment system until it reaches its end destination. If the water is to be used closely, no chlorine treatment is necessary.

In the water treatment system shown in FIG. 11, a water stream will enter through entrance 200, and will pass through a screen 205. The screen 205 removes larger particles which can sometimes be found in untreated water.

The water then passes from the screen 205 to a venturi 220 where the water is injected with ozone produced by ozone generator 230. In this embodiment of the water treatment system, the ozone generator 230 includes several additional mechanisms which increase its efficiency. These are a preliminary air treatment means 232 which cools and dries the air destined for the ozone generator, and an oxygen generator means 234 which takes the cooled and dried air and separates the oxygen from the other gasses which naturally occur in air. As a result a much larger concentration of oxygen is fed into the ozone generator 230, thus making the ozone generation much more efficient and less likely to breakdown.

Finally, the ozone generator 230 is fitted with a water cooling system 236 which cools the ozone generator 230, and insures that it does not overheat again increasing its efficiency.

After the water stream has been injected with ozone, the water flows into a depressurized reaction chamber 240, wherein it is stored until the ozone has had sufficient time to react with the pollutants in the water. The depressurized reaction chamber can also include an ozone destroyer or vent 245 which removes any left over gaseous ozone from the chamber.

Finally, the water stream is passed through a sand filter 250 which removes the oxidized pollutants from the water stream. If required, the water stream is then injected with chlorine from storage tanks 260 and 262, before being sent to its final destination 290.

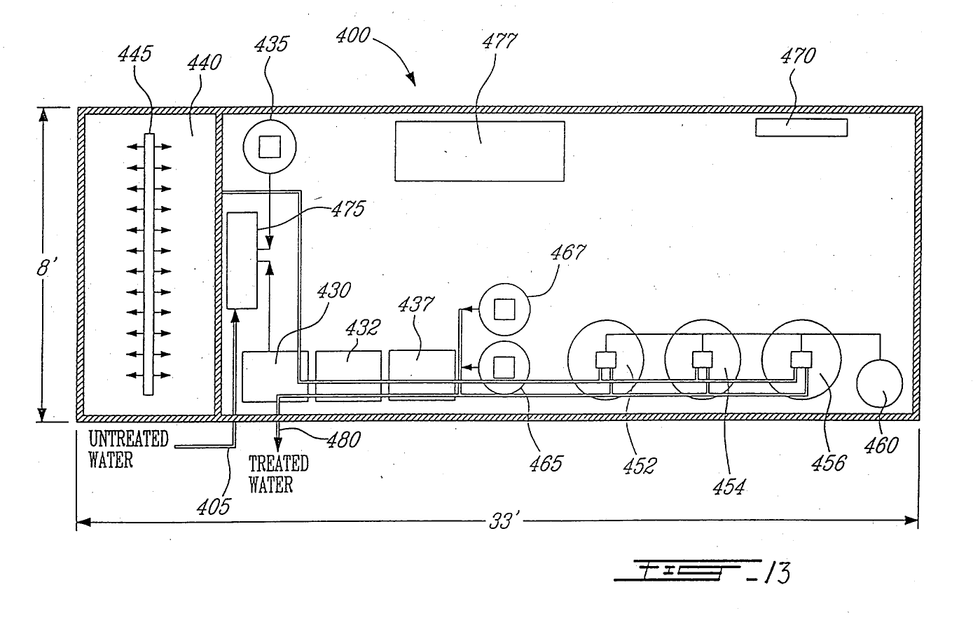

FIG. 12 shows another embodiment of the present invention, in which a complete water treatment system has been built into an easily transportable container. In this embodiment the water treatment system has been designed for compactness and ease of installation for a client. This embodiment is especially useful for large scale applications such as use as a small town's main potable water treatment facility. The reason for this is that large scale water treatment systems, for instance municipal water treatment, often take up large amounts of space and require the construction of a building to house it.

Therefore, if the water treatment system was to be built on site, an even larger area would be needed and specialized workers would need to the present during the installation period. This is especially costly and inconvenient when the installation site is faraway. On the other hand if a water treatment system according to the present embodiment of the invention were to be used, then the water treatment system could be assembled and tested at a site distant from its final location. The water treatment system could then be easily transported to the final location and would simply need to be connected to the water network, and a suitable power supply.

As can be seen in FIG. 12, the water treatment system in the present embodiment may be situated in a standard container 300 (for example an 8 feet by 33 feet container). Water enters through entrance port 305 comprising a screen and passes through two filtration stages 310 and 312 in which larger (20 microns or more) particles are first removed and then smaller (5 microns or more) particles are removed. The water can then either be passed through an ozonisation cycle or just be cycled back into the water network if no treatment is required.

In the embodiment shown in FIG. 12, water going through an ozonization stage may first be treated with other chemicals, for instance chlorine to reduce the amount of pollutants in the water before being injected with ozone produced by ozone generator 330 using a venturi 320. After being injected with ozone, the water is stored in a reaction chamber 340 for sufficient time to allow the ozone to react with the pollutants in the water.

After the appropriate time has passed, the water is passed through filters 350 and 355 before being sent into the water network 390.

The water treatment system of the embodiment shown in FIG. 12, additionally has an electrical control box 370 through with the water system can be controlled, and an entrance door 302 which allows access to the water treatment system.

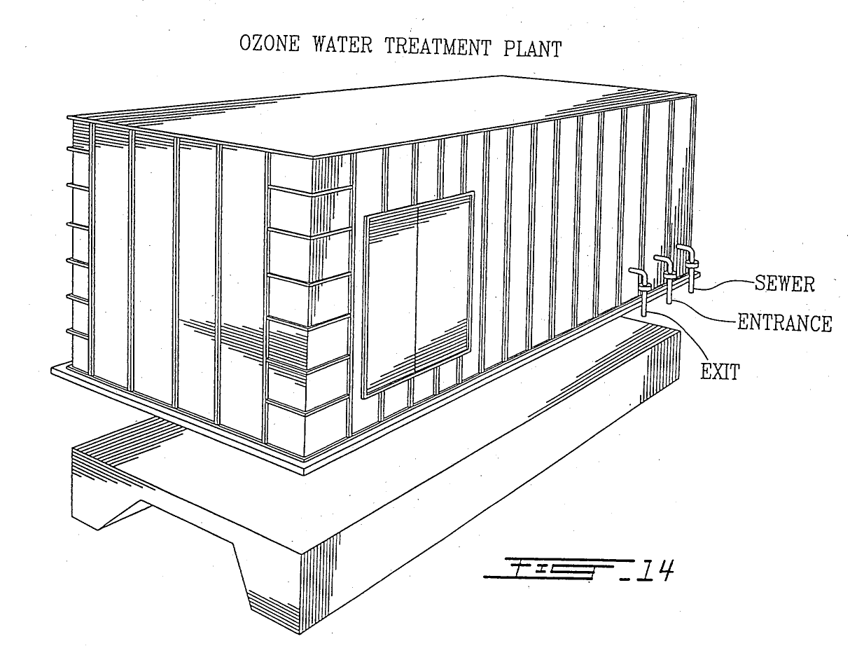

FIG. 13, shows another embodiment of a water treatment system 400 according to the invention which has been designed to be mobile and self contained. In this embodiment we can see the flow of water through the water treatment system 400. The water would enter the water treatment system 400, at point 405 and leave at point 480. As the water enters the water treatment system 400, it first comes to control station 475 where the water is treated with ozone produced by ozone generators 430 and 432 and other chemicals as needed to maintain the pH balance of the water.

This embodiment of the invention contains ozone generators 430 and 432 which are fitted with air dehumidifier and cooler 437. The chemical products needed to maintain the pH balance of the water are stored in contained 435.

After being ozonated the water is allowed to pass to a reaction chamber 440, containing a diffuser 445. The diffuser 445 works to diffuse the ozone in the water thereby increasing efficiency of the ozone. The water stays in the reaction chamber 440 for a time which is sufficient to allow the ozone to react with the pollutants in the water.

The water then passed to sand filters 452, 454, and 456 which work in parallel to filter out the ozonated pollutants of the water stream. The sand filters 452, 454, and 456 are also connected to chlorine reservoir 460 such that chlorine may be used to make sure the filters remain free of live bacteria.

Finally, the water stream passes by chlorine pumps 465 and 467 which may introduce chlorine in to the water stream to insure that the treated water will not be recontaminated when circulating in the water distribution network.

In this embodiment of the invention the water treatment system also includes a work post 477 at which a human operator may monitor the system, and a control panel 470 for controlling the system.

FIG. 14, shows a possible housing for the embodiment of the water treatment system shown in FIGS. 12 and 13.

While the principles of this invention has been described in connection with specific embodiments, it should be understood clearly that these descriptions, along with the chosen examples and data, are made only by way of illustration and are not intended to limit the scope of this invention, in any manner. Various other ozonation systems and/or configurations can be used in conjunction with the invention. Many modifications and other embodiments of the invention will come to the mind of one skilled in the art having the benefit of the teachings presented in the foregoing descriptions and the associated drawings. No concerted attempt to repeat here what is generally known to the artisan has therefore been made. Therefore, it is to be understood that the invention is not to be limited to the specific embodiments disclosed, and that modifications and embodiments are intended to be included within the appended claims with the scope thereof determined by the reasonable equivalents, as understood by those skilled in the art.

1. A water treatment apparatus to purify water coming from an external water source as water flows in said apparatus, said water source containing unwanted particles and/or substances and/or having high levels of turbidity, said apparatus comprising:
a transportable housing which is adapted to be connected to said water source;
a first filter which removes a portion of said unwanted particles from said water source;
a disinfectant generator system which produces and provides disinfectant,
a mixer which mixes said disinfectant with said water source from said first filter;
a reactor which defines an inner chamber connected to said mixer and favors the molecular reaction of said water source with said disinfectant to remove a significant portion of any remaining said unwanted particles and/or substances and inactivate another portion of the left said unwanted particles and/or substances;

2. An apparatus as claimed in claim 1, wherein said apparatus involves no chemical reactions other than said disinfectant.

3. An apparatus as claimed in claim 2, wherein said first filter is a screening with a fixedly attached membrane.

4. An apparatus as claimed in claim 3, wherein said screening is cylindrical.

5. An apparatus as claimed in claim 4, wherein said water source axially enters said screening and vertically exit said screening by gravity.

6. An apparatus as claimed in claim 5, wherein said screening is rotative.

7. An apparatus as claimed in claim 6, wherein said screening comprises cleaning means and cleaning detectors.

8. An apparatus as claimed in claim 7, wherein said cleaning means are water jet means to clean said fixedly attached membrane, said water jet means are actuated when water accumulates in said screening to a certain pre-determined water level detected by said cleaning detectors.

9. An apparatus as claimed in claim 1, wherein said disinfectant generator system produces ozone as a disinfectant.

10. An apparatus as claimed in claim 1, wherein said mixer is a venturi.

11. An apparatus as claimed in claim 1, wherein said chamber of said reactor has walls perpendicularly disposed with respect to said flow of said water source.

12. An apparatus as claimed in claim 11, wherein said walls are vertically located at different heights such that said water source flows through said chamber and follows an “s” path.

13. A water treatment apparatus to purify water coming from an external water source as water flows in said apparatus, said water source containing unwanted particles and/or substances and/or having high levels of turbidity, said apparatus comprising:
a transportable housing which is adapted to be connected to said water source;
a first filter which removes a portion of said unwanted particles from said water source;
a disinfectant generator system which produces and provides disinfectant, a mixer which mixes said disinfectant with said water source from said first filter;
a reactor which defines an inner chamber connected to said mixer and favors the molecular reaction of said water source with said disinfectant to remove a significant portion of any remaining said unwanted particles and/or substances and inactivate another portion of the left said unwanted particles and/or substances;
a second filter which removes another portion of said unwanted particles and/or substances from said water source;
a third filter which lowers the turbidity level and lowers said disinfectant in said water source;
a fourth filter which lower said inactivated unwanted particles and/or substances from said water source.

14. An apparatus as claimed in claim 13, wherein said second filter contains a first screening and a second screening.

15. An apparatus as claimed in claim 14, wherein said first and second screening are cylindrical.

16. An apparatus as claimed in claim 15, wherein said first screening has a first diameter and a first fixedly attached membrane and said second screening has a second diameter different than said first diameter and a second fixedly attached membrane.

17. An apparatus as claimed in claim 16, wherein said first and said second screenings are concentric.

18. An apparatus as claimed in claim 17, wherein said first and said second membrane are vertically in-line.

19. An apparatus as claimed in claim 18, wherein said water source axially enters into said first screening, diffuses out of said first screening through said first membrane and into second screening, said water source further diffuses out of said second screening through said second membrane by gravity.

20. An apparatus as claimed in claim 19, wherein said first and said second screenings are independently rotatable.

21. An apparatus as claimed in claim 20, wherein said first screening and said second screening each comprises cleaning means and cleaning detectors.

22. An apparatus as claimed in claim 21, wherein said cleaning means are water jet means to clean said first and said second membrane, said water jet means are actuated when water accumulates in said first and said screening to a certain pre-determined water level detected by said cleaning detectors.

23. An apparatus as claimed in claim 13, wherein said third filter has an entrance, a plurality of longitudinally extending hollow members connected to said entrance, a channel accessible from every said hollow members and an exit connected to said channel, such that said water source enters said filter at said entrance, then flows into said hollow members, then it is forced to diffuse to said channel by leaving a portion of left said unwanted particles inside said hollow members, and then leaves said filter from said exit.

24. An apparatus as claimed in claim 23, wherein said water enters said filter with a specific concentration of said disinfecting means such that said unwanted particles are reduced inside of said hollow members.

25. An apparatus as claimed in claim 24, wherein said disinfecting means is ozone and said hollow members are ozone resistant membranes.

26. An apparatus as claimed in claim 13, wherein said third filter has an entrance, a channel connected to said entrance, a plurality of longitudinally extending hollow members accessible from said channel and an exit connected to said hollow members, such that said water source enters said filter at said entrance, then flows into said channel, then it is forced to diffuse to said hollow members by leaving a portion of left said unwanted particles outside said hollow members, and then leaves said filter from said exit.

27. An apparatus as claimed in claim 26, wherein said water enters said filter with a specific concentration of said disinfecting means such that said unwanted particles are reduced outside of said hollow members.

28. An apparatus as claimed in claim 27, wherein said disinfecting means is ozone and said hollow members are ozone resistant membranes.

29. An apparatus as claimed in claim 13, wherein said apparatus further comprises an independent cleaning system for said apparatus.

30. An apparatus as claimed in claim 29, wherein said cleaning system comprises a detergent provider, a treated water source which is provided by said apparatus and UV lamps.

31. An apparatus as claimed in claim 13, wherein said apparatus is fully automated.

32. An apparatus as claimed in claim 31, wherein said automated apparatus comprises real time monitoring means for water quality and data recording means for water data.

33. An apparatus as claimed in claim 13, wherein said apparatus provides drinkable water quality from said water source.

34. A method of installing a water treatment system using an ozone generator means at an installation location, said method comprising the steps of:
a. building the water treatment system at a location remote to the installation location;
b. installing the water treatment system in an enclosure such that the water treatment system can be relocated by moving the enclosure, and such that the water treatment system can treat a water source external to said enclosure without being removed from said enclosure;
c. transporting said enclosure to the installation location; and
e. installing the enclosure at the installation location.

35. A method as claimed in claim 34 wherein said housing is a freight container.
